(19) United States
(12) Patent Application Publication
(10) Pub. No.: US 2006/0237994 A1
(43) Pub. Date: Oct. 26, 2006

(54) Car body attachment part for a motor vehicle and method of producing such car body attachment part

(76) Inventors: Matthias Ludwig, Vechelde (DE); Frank Niebuhr, Wilsche (DE); Harald Batke, Mueden/Aller (DE); Hans-Joachim Langhoff, Gifhorn (DE); Tobias Niesner, Gifhorn (DE); Sven Hardel, Wettendorf (DE); Herbert Beck, Wolfenbuettel (DE)

Correspondence Address: CARLSON, GASKEY & OLDS, P.C., 400 WEST MAPLE ROAD, SUITE 350, BIRMINGHAM, MI, 48009, US

(21) Appl. No.: 11/402,171

(22) Filed: Apr. 11, 2006

(30) Foreign Application Priority Data
Apr. 21, 2005 (EP) 05 008 753.5

(51) Int. Cl. B62D 29/04

(52) U.S. Cl. 296/191

(57) ABSTRACT

A car body attachment part, when mounted to a motor vehicle, has an inner side comprising a surface portion, and an opposite, visible outer side. A method for producing the car body attachment part includes the following steps. A foaming mold is provided that includes a first tool mold die and a second tool mold die. The inner side of the car body attachment part is associated with the first tool mold die, and the outer side is associated with the second tool mold die. Next, a protective foil is inserted in the first tool mold die, at least in a region of the surface portion. The protective foil is provided with a foam backing so that the inner side in the region of the surface portion is constituted by the protective foil. The protective foil is connected with the foam backing such that the protective foil can be peeled off from the foam backing in a non-destructive manner. The car body attachment part is particularly useful as a roof module mounted to a roof of a motor vehicle.

### RELATED APPLICATIONS

The application claims priority to European Application No. 05 008 753.5, which was filed on Apr. 21, 2005.

### BACKGROUND OF THE INVENTION

The invention relates to a car body attachment part for a motor vehicle and a method of producing the car body attachment part.

Foamed car body attachment parts, in particular those including a glass-fiber reinforced polyurethane (PU) material, are already known. These foamed car body attachment parts have glass fibers that are injected in plastic by using a so-called long fiber injection method (LFI), for instance. A deep-drawn foil outer skin made of plastic or aluminum is placed in a foaming mold and is provided with a foam backing. When the PU material has reacted to foam, the car body attachment part has to be taken out of the foaming mold without damaging the car body attachment part.

One known method for avoiding such damage, is to use releasing agents that are applied prior to the foaming process on the foaming mold lying opposite the outer skin. This allows the foamed car body attachment part to be taken out without difficulty. These releasing agents are usually applied by spraying, resulting in contamination and soiling of an abutment surface against the mold by an atomized spray.

Due to this contamination and soiling, the car body attachment parts, prior to being mounted to a vehicle frame, have to be cleaned at designated adhesive surfaces in order to ensure good adhesion of an adhesive. With a car body attachment part that is formed as a roof module, the adhesive surfaces are situated, for instance, at lateral edges of the roof module.

It is the object of the invention to provide a car body attachment part that is low-priced, eliminates the above-mentioned difficulties with the prior art, and which can be produced in a simple manner.

### SUMMARY OF THE INVENTION

The subject invention accomplishes this by a method of producing a car body attachment part which, related to a state when mounted to a motor vehicle, has an inner side and an opposite, visible outer side, where the inner side comprises a surface portion.

The method includes the following steps. A foaming mold is provided that includes a first tool mold die and a second tool mold die. The inner side of the car body attachment part is associated with the first tool mold die and the outer side of the car body attachment part is associated with the second tool mold die. A protective foil is inserted in the first tool mold die at least in a region of the surface portion. The protective foil is provided with a foam backing so that the inner side, in the region of the surface portion, is constituted by the protective foil, with the protective foil being connected with a produced foam layer such that the protective foil can be peeled off from the foam layer in a non-destructive manner.

The protective foil that forms the inner side in the region of the surface portion, and thus covers the surface portion, protects this inner side against contaminants such as dust and releasing agents. Contamination may occur, inter alia, during transportation of a finished car body attachment part to a car manufacturer. Due to the protective foil, it is now possible to deliver the car body attachment part to the car manufacturer without difficulty. The car manufacturer can attach the car body attachment part to the vehicle without having to clean the surface portions as when releasing agents were used. This is accomplished by peeling off the protective foil from the foam layer in a non-destructive manner. The term “non-destructive” means that the foam layer does not adhere to the surface of the protective foil during peeling off, so that a desired smooth foam layer surface will be maintained. These surface portions were previously required to be cleaned.

Typically, a releasing agent had been provided in the foaming mold. With the inventive method, no releasing agent is applied on the first tool mold die prior to inserting the protective foil. The protective foil allows the foamed car body attachment part to be taken out of the foaming mold without any difficulty. As a result, application of the releasing agent may be eliminated as well as the cleaning of the foaming mold and the associated surrounding area.

Preferably, during the foaming process, a foam layer is produced, with the protective foil covering the entire foam layer of the first tool mold die on the inner side. In this way it is not necessary to apply any releasing agent in the entire area of the first tool mold die. This simplifies the manufacturing process and decreases cost.

The first tool mold die may have holes that are in communication with a pump, which can be used to apply a vacuum. The extensible protective foil will be in tight contact with a contour of the first tool mold die when the pump is actuated and a vacuum is produced. As a result, after the foaming process, the car body attachment part has a desired contour that corresponds to the first tool mold die.

The protective foil is preferably a polyethylene (PE) foil. The PE foil is a thin, flexible and extensible foil.

An adhesion-eliminating coating may be applied on the protective foil in order to facilitate a peeling off of the protective foil. The adhesion-eliminating coating can be applied either on one side, or on both sides, of the protective foil.

Preferably, prior to the foaming process, a foil outer skin is inserted in the second tool mold die. The foil outer skin will form an outer side of the car body attachment part. The foil outer skin is an aluminum or plastic foil, with the latter being dyed throughout, for instance, so that an external lacquering can be omitted. Preferably, the foil outer skin is deep-drawn prior to insertion.

The car body attachment part made according to the inventive method, is preferably designed for a motor vehicle, in particular a roof module. The car body attachment part, when mounted to a motor vehicle, has an inner side, an opposite, visible outer side and a protective foil. The inner side comprises a surface portion that is defined by a foam layer. The protective foil is disposed on the surface portion and is capable of being peeled off from the foam layer in a non-destructive manner. Due to the protective foil, the surface portion is protected against contaminants such as dust, because the protective foil covers the surface portion in particular during transporting the finished car body attachment part to a car manufacturer.

As already stated, it is preferred that releasing agents not be applied on the protective foil or the foaming mold. If the surface portion is an adhesive surface, the step of removing the releasing agent from the adhesive surface, which would have to be done before any contact with an adhesive, is thus eliminated.

These and other features of the present invention can be best understood from the following specification and drawings, the following of which is a brief description.

### BRIEF DESCRIPTION OF THE DRAWINGS

FIG. 1 shows a perspective view of a car body attachment part according to the invention, in the form of a roof module.

FIG. 2 shows a sectional view of the roof module.

FIG. 3 shows a sectional view of a foaming tool, with a protective foil and a foil outer skin inserted in the foaming tool.

### DETAILED DESCRIPTION OF THE PREFERRED EMBODIMENT

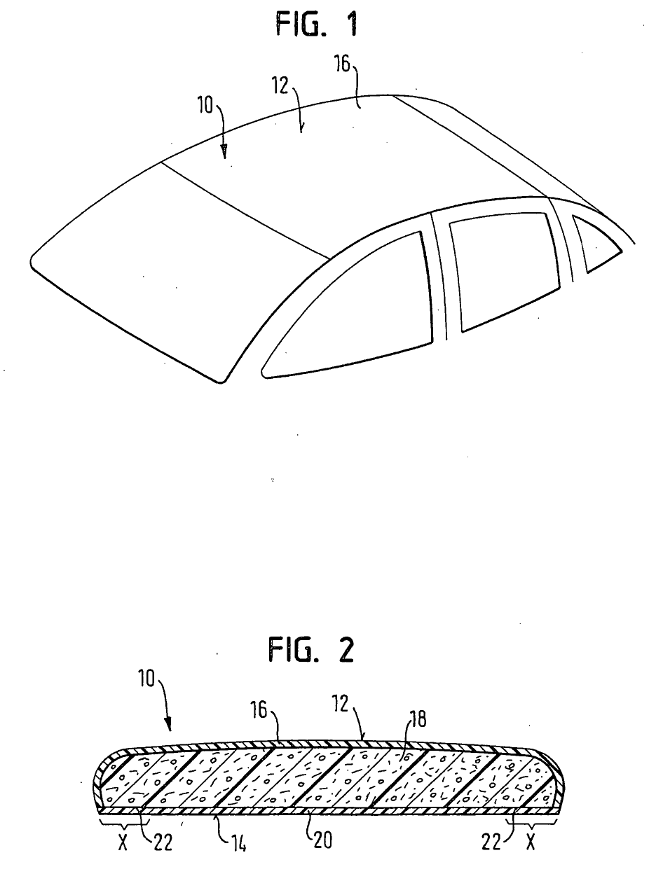

FIG. 1 shows a car body attachment part of a vehicle in the form of a foamed roof module 10. Instead of being used as a roof module, the car body attachment part could also be used as a fender, a door, or flap component such as an engine hood, trunk lid, fuel tank cap, etc. on the vehicle.

When mounted to the vehicle, the foamed roof module 10 has a visible outer side 12 and an inner side 14 (FIG. 2) opposite to the outer side 12. The outer side 12 is defined by a thin, deep-drawn foil outer skin 16 that is preferably made of aluminum or of plastic that is dyed throughout.

Directly adjoining the foil outer skin 16 is a foam layer 18 formed from a fiber-reinforced PU foam. Glass fibers are incorporated into the PU foam by an LFI method, which reinforces the foam layer 18. The foam layer 18 in FIG. 2 has an almost constant thickness across an entire length as shown, but could also be realized to have a varying thickness.

Extending across the entire inner side 14 is a thin, flexible PE protective foil 20 that completely defines the inner side 14. The protective foil 20 could also be arranged only in a surface portion to cover any adhesive surfaces 22, which are provided at lateral edges in an area X (FIG. 2) of the foamed roof module 10. The adhesive surfaces 22 are provided to lie at an underside of the foam layer 18, i.e. directly underneath the protective foil 20 in the area X. An adhesive may be applied on the adhesive surfaces 22, to affix the foamed roof module 10 to the vehicle by gluing, in particular by gluing to the roof frame. This is why the protective foil 20 can be peeled off in a non-destructive manner. Thus, the protective foil 20 will be removed prior to applying an adhesive on the adhesive surfaces 22, but until the protective foil 20 is removed, the protective foil 20 serves as a protective layer for the inner side 14 of the foamed roof module 10 for protection against soiling, contamination, scratches etc.

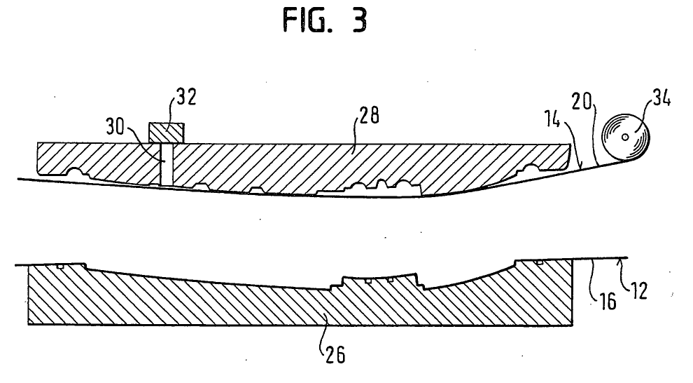

FIG. 3 illustrates a foaming tool that is used to produce car body attachment parts such as the initially mentioned roof module 10, fenders, doors or flaps (engine hood, trunk lid etc.) of the vehicle.

The foaming tool includes two tool mold dies, namely one tool bottom part 26 and one tool upper part 28. The tool upper part 28 has a hole 30 that is in communication with a schematically shown pump 32, the function of which will be explained below. Although only one hole 30 is shown, there could also be a plurality of holes.

To produce the foamed roof module 10, the deep drawn foil outer skin 16 with inherent rigidity is inserted in the tool bottom part 26. This occurs without previously applying a releasing agent, with the foil outer skin 16 already being adapted to a contour of the tool bottom part 26.

The tool upper part 28 is covered by a thin protective foil 20 that is unreeled from a stationary roll 34, likewise without applying any releasing agent on the tool upper part 28. The protective foil 20 covers an entire underside of the tool upper part 28 and is, other than the foil outer skin 16, not adapted to a contour of the tool upper part 28. The tool upper part 28 is provided with several indentations, but the protective foil 20 is just “loosely” inserted. A vacuum is produced by the pump 32, and the protective foil 20 is sucked to lie against the underside of the tool upper part 28.

With the foaming tool being open, liquid PU material is applied on a rear side of the foil outer skin 16, with glass fibers being injected using the LFI method.

The tool bottom part 26 and tool upper part 28 are moved towards each other. The PU material reacts to foam and fills a cavity that is formed between the tool bottom part 26 and the tool upper part 28. After foaming, the foam layer 18 will have the shape of this cavity.

When the tool bottom 26 and upper 28 parts have been moved away from each other, and after trimming an edge, the foamed roof module 10 with the protective foil 20 can be delivered to a car manufacturer. The protective foil 20 also acts as a protective foil during further working processes (e.g. trimming the edge), and prevents soiling of the adhesive surfaces 22.

Prior to mounting the roof module 10 to the vehicle, the protective foil 20 is peeled off from the foam layer 18, an adhesive is applied on the adhesive surfaces 22 or on the roof frame, and the roof module 10 is bonded to the roof frame of the vehicle.

Instead of using the hole 30 and the associated pump 32, the protective foil 20 would also be able to conform to the contour of the tool upper part 28 merely by the foaming pressure, so that the inner side 14 of the foamed roof module 10 has the desired contour.

Generally speaking, the protective foil 20 protects the inner side 14 of the roof module against contamination, soiling and scratches, in particular during further machining operations at the car manufacturer. It is also possible, of course, that the protective foil 20 covers the entire inner side 14 or other surface portions, as an alternative to covering the lateral adhesive surfaces 22 that are shown here.

Additionally, an interior roof lining may be inserted in the foaming mold, namely at a side of the protective foil 20 facing the outer side 12. In doing so, the interior roof lining will not cover the entire inner side 14, but will only cover the central zone, as is known. The protective foil 20 will then be peeled off from the interior roof lining in a non-destructive manner.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of producing a car body attachment part adapted for mounting to a motor vehicle, the car body attachment part having an inner side and an opposite, visible outer side, the inner side comprising a surface portion, wherein the method includes the following steps:
(a) providing a foaming mold including a first tool mold die and a second tool mold die, the inner side of the car body attachment part being associated with the first tool mold die and the visible outer side being associated with the second tool mold die;
(b) inserting a protective foil in the first tool mold die at least in a region of the surface portion; and
(c) providing the protective foil with a foam backing so that the inner side, in the region of the surface portion, is constituted by the protective foil, with the protective foil being connected with the foam backing such that the protective foil can be peeled off from the foam backing in a non-destructive manner.

2. The method of producing a car body attachment part according to claim 1 including not applying a releasing agent on the first tool mold die prior to inserting the protective foil.

3. The method of producing a car body attachment part according to claim 1 producing the foam backing during a foaming process, with the protective foil covering an entire foam layer of the first tool mold die on the inner side.

4. The method of producing a car body attachment part according to claim 1 wherein the first tool mold die has at least one hole that is in communication with a pump through which a vacuum can be applied.

5. The method of producing a car body attachment part according to claim 1 wherein the protective foil is a polyethylene foil.

6. The method of producing a car body attachment part according to claim 1 including applying an adhesion-eliminating coating on the protective foil.

7. The method of producing a car body attachment part according to claim 1 including, prior to a foaming process, inserting a foil outer skin in the second tool mold die, with the foil outer skin forming the visible outer side of the car body attachment part.

8. The method of producing a car body attachment part according to claim 7 including deep drawing the foil outer skin prior to insertion.

9. The method of producing a car body attachment part according to claim 1 wherein at least a part of the surface portion that is covered by the protective foil is a peripheral adhesive surface at which the car body attachment part is glued to the motor vehicle.

10. A car body attachment part for a motor vehicle comprising:
an inner side;
a visible outer side opposite the inner side; and
a protective foil, wherein the inner side comprises a surface portion that is defined by a foam layer, with the protective foil being disposed on the surface portion to comprise a peelable layer that is selectively peeled off from the surface portion in a non-destructive manner.

11. The car body attachment part according to claim 10 wherein the protective foil does not contact a releasing agent.

12. The car body attachment part according to claim 10 wherein the surface portion is a peripheral adhesive surface at which the car body attachment part is to be glued to the motor vehicle.

13. The car body attachment part according to claim 10 wherein the protective foil forms an entire area of the inner side.

14. The car body attachment part according to claim 10 wherein the car body attachment part comprises a roof module adapted for attachment to the motor vehicle.
